(19) United States
(12) Patent Application Publication
(10) Pub. No.: US 2013/0145289 A1
(43) Pub. Date: Jun. 6, 2013

(54) REAL-TIME DUPLICATION OF A CHAT TRANSCRIPT BETWEEN A PERSON OF INTEREST AND A CORRESPONDENT OF THE PERSON OF INTEREST FOR USE BY A LAW ENFORCEMENT AGENT

(71) Applicants: MOHAMMED ABDUL-RAZZAK, Union City, CA (US); Subhrajyoti Ray, San Jose, CA (US)

(72) Inventors: MOHAMMED ABDUL-RAZZAK, Union City, CA (US); Subhrajyoti Ray, San Jose, CA (US)

(73) Assignee: SS8 Networks. Inc., Milpitas, CA (US)

(21) Appl. No.: 13/312,818

(22) Filed: Dec. 6, 2011

(51) Int. Cl. G06F 3/01; G06F 15/16

(52) U.S. Cl. 715/758

(57) ABSTRACT

Systems and methods of automatic notification, collection and real-time replication of online chat conversations between a POI and a correspondent of the POI are disclosed. In one embodiment, the method may include automatically notifying an analyst when an online chat conversation associated with the POI has commenced. The method may also include generating a real-time viewable version of the online chat conversation in a duplicate transcript. The method may further include screening and organizing a set of online chat conversations associated with the POI based on a set of predetermined screening criteria.

### FIELD OF TECHNOLOGY

This disclosure relates to an automatic notification and simultaneous duplication of an online chat conversation between a person of interest (POI) and a correspondent of the POI to be used by a law enforcement agent.

### BACKGROUND

An analyst (e.g., a law enforcement analyst, a financial analyst, an analyst managing finance/stocks/mutual-funds, an analyst at an IT department, a marketing analyst, a local police officer, a secret agent, a member of an intelligence agency etc.) may want to monitor a person of interest (POI) to understand a set of interacts he may have with a set of correspondents or contacts. The analyst may want to instantaneously view and analyze a communication between a POI and the correspondent. In many situations, the investigation may be time sensitive and may require immediate assistance from the analyst, and/or may be an urgent matter dealing with dangerous criminals endangering the public at large. In many cases, the analyst may not be able to reproduce an important conversation that occurred between the POI and the correspondent of the POI instantaneously in a time-critical manner. This, in turn, may mean that the analyst may miss an important lead, and may end up wasting time and energy on a case that may have been resolved much faster. Such inefficiencies may prove costly for the analyst in addition to causing financial losses to relevant parties involved in the case. Finally, the delayed investigation may mean that the POI remains a public threat for a longer period of time, thereby endangering lives and property.

### SUMMARY

This disclosure relates to an automatic notification and simultaneous duplication of an online chat conversation between a person of interest (POI) and a correspondent of the POI to be used by a law enforcement agent.

In one aspect, a method may include automatically receiving a notification at a workstation associated with an analyst when a person of interest (POI) engages in an online chat conversation having at least one of a text, voice and video capability with a correspondent of the POI. The method also includes generating, in a real time, a viewable version of the online chat conversation at the workstation associated with the analyst simultaneously as a note of the online chat conversation is transmitted to the correspondent of the POI.

In another aspect, a method may include automatically generating a notification to an analyst when a person of interest (POI) engages in an online chat conversation with a correspondent of the POI. The method also includes generating, in a real time, a viewable version of the online chat conversation at a workstation associated with the analyst. The method further includes screening the online chat conversation based on a set of predetermined keywords to automatically generate a priority level of the online chat conversation.

In yet another aspect, a system comprising a processor communicatively coupled with a volatile memory and a non-volatile storage further comprising a notification module, to automatically generate a notification to an analyst when a person of interest (POI) engages in an online chat conversation having at least one of a text, voice and video capability with a correspondent of the POI. The system also includes a real-time media replication module, to generate, in a real time, a viewable version of the online chat conversation, simultaneously as a note of the online chat conversation is transmitted to the correspondent of the POI. The system further includes a workstation associated with an analyst, to view the viewable version of the online chat conversation between the POI and the correspondent of the POI.

The methods and the systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates the system architecture showing the chat notification module, and the screening module being communicated at the workstation to the analyst.

FIG. 2 illustrates the system overview illustrating a network (WAN), the collection server, the communication bus, the real-time media replication module, the screening module, the notification module and the workstation.

FIG. 3 illustrates a closer view of the service platform and the collection server further containing the notification module and the screening module.

FIGS. 4A and 4B illustrates a detailed view of the extraction and duplication of the online chat conversation between the POI and the correspondent of the POI.

### DETAILED DESCRIPTION

This disclosure relates generally to an automatic notification and simultaneous duplication of an online chat conversation between a person of interest (POI) and a correspondent of the POI to be used by a law enforcement agent. In the following description, for the purposes of explanation, numerous specific details are set forth in order to provide a thorough understanding of the various embodiments. It will be evident, however, to one skilled in the art that the various embodiments may be practiced without these specific details.

System Overview

The application discloses a method and system to automatically, screen notify and relay a set of collected data to an analyst when a POI engages in an online chat conversation with a correspondent of the POI. In one or more embodiments, an analyst of the system may be an analyst at a law enforcement agency, or a management consultancy and may want to collect, consolidate, analyze and visualize a set of raw data acquired through legal means. In one or more embodiments, the analyst may be a part of an intelligence agency, a police force, a law enforcement consulting company and/or management company. In one or more embodiments, the analyst may be part of an investigation. The investigation may be a criminal investigation, a civil investigation, an investigation of an employee violating a corporate regulation/conduct, investigation to ascertain compliance with laws and regulations as well as creating reports verifying such compliance, an investigation to save money and/or resources for a company or any other investigation.

A. Data Collection and Screening

In one or more embodiments, the system may comprise of a collection server that may further comprise a set of collection interface modules that receive legally collected data. In one or more embodiments, the legally collected data may be a set of communication and transaction data between a person of interest (POI) and a set of correspondents of the POI. In one or more embodiments, the collection interface module may receive a set of communication and transaction data associated with a communication between the POI and a correspondent of the POI. In one or more embodiments, the POI may be a suspect in a criminal investigation, a lead in a criminal investigation, or any person of interest in a criminal and/or civil investigation. The correspondent of the POI may be an individual or an entity, in one or more embodiments. The correspondent of the POI may be any individual or entity that may communicate by any means with the POI, in one or more embodiments. In one or more embodiments, the POI may communicate with many correspondents of the POI as denoted as A, B, C, etc.

In one or more embodiments, there may be a set of collection servers spread through a region with an ability to connect to any network to receive the set of communication and transaction data of interest from the network. In one or more embodiments, the collection server may further include a storage module, a collection interface module and a data processing engine.

In one or more embodiments, the POI may initiate and/or engage in an online chat conversation with a correspondent of the POI. In one or more embodiments, the online chat conversation could contain text, video, audio and any other type of data attachment. In one or more embodiments, the collection interface module may receive a set of data corresponding to an online chat conversation between the POI and the correspondent of the POI. In one or more embodiments, the online chat conversation may only contain text. In one or more embodiments, the online chat conversation may also include voice, video, audio and/or data attachments. In one or more embodiments, the online chat conversation may be carried out through a chat carrier. In one or more embodiments, the online chat conversation may refer to any real-time IP communication between the POI and the correspondent of the POI. In one or more embodiments, the online chat conversation may contain several notes exchanged by the POI and correspondents of the POI. In one or more embodiments, the online chat conversation may refer to chat conversations between more than 2 people. For example, the POI may have a group chat conversation between correspondent B and correspondent C.

In one or more embodiments, the collection interface module may further be linked to a data processing engine that may sort and organize the set of communication and transaction data collected from the network. The data processing engine may then process the set of communication and transaction data to extract a metadata and a content of the set of communication and transaction data. The collection interface module may then collect the set of communication and transaction data sent to these collection servers. The set of communication and transaction data may consist of a metadata (e.g. IP address, email address, cyber-address recipient address, sender address, time of the email, time of the mail, information on a post card, etc.). The metadata may be an information about the data in one or more embodiments. The metadata may encompass a time and place that the data was received. The metadata also encompass a set of information related to the senders and receivers of the information, a time of a communication event, or where an information was collected from. For example, if an email is sent to the POI, the metadata may consist of the sender and recipient addresses of the email, an IP address and a time of the email among others. The data may also consist of a content. The content may be the substantive part of the data collected. The data may consist of the actual text of the email, attachments in the email and what the information actually says. In the previous example, the content may be the actual text of the email which may be a solicitation for a crime. The system may make a distinction between content and metadata.

In one or more embodiments, the metadata may also be a cyber-name, a cyber-address, contact list, an analyst login information, a chat IP address, a chat alias, a VOIP address, a web forum login, a website login, a social network login, a sender and/or receiver of a chat, a time of a chat conversation, a file name sent in a chat or an email or any other cyber-communication, a number of files transferred in the cyber communication, a type of chat text, a name of an audio and/or video attachment sent in the cyber communication, a number of parties involved in a communication, a buddy list, an avatar description associated with the cyber communication. The metadata may also be associated with voice and/or voice over IP communications. The metadata may also be associated with social networking sites, and may include an analyst name, a time of a social networking communication or publication, a size of a social networking communication, a number of followers and others. The metadata may also include telephone numbers, phone numbers, IMSI information and/or IMEI information.

Similarly, the content may include the substantive portion of a record. In addition to the text of the communication, or a transcript of a recorded conversation, it may also include a text of an email attachment, a transferred file, a content of an uploaded or downloaded document/video or any other file, a pooled information between many users, a substance of social network communication, a tweet, a message exchanged between two parties, a substance of a text message, and any other communication.

In one or more embodiments, the collection interface module and the data processing engine may process the set of communication and transaction data to extract the metadata and the content of the set of the communication and transaction data. For example, the POI may initiate an online chat conversation with a correspondent of the POI. The collection interface module may immediately collect the set of communication and transaction data associated with online chat conversation between the POI and the correspondent of the POI. In one or more embodiments, the data processing engine may separate the contents of the online chat conversation to generate a metadata of the online chat conversation and a content of the online chat conversation. For example, the metadata of the online chat conversation may be an identity of the correspondent of the POI, and a time and a date of the online chat conversation. The content of the online chat conversation may be an actual transcript of the online chat conversation.

In one or more embodiments, the collection server may store the content in the storage module of the collection server. In one or more embodiments, the metadata and any text content may be transmitted to the service platform through a communication bus.

In one or more embodiments, the communication bus may be a mode of electronic transportation linking the set of collection servers sprawled across the network. In one or more embodiments, the metadata and any text content may be automatically transmitted to the database in the service platform. In one or more embodiments, the storage module may hold data records of the database. In one or more embodiments, the analyst at the service platform may then be able to immediately access the metadata and text content to analyze and visualize the set of communication and transaction data. If the analyst does decide to view the content, the analyst may request the information stored in the storage module and the content may then be transmitted to the analyst through the communication bus.

In one or more embodiments, the service platform may be connected to the collection servers through the communication bus. In one or more embodiments, the service platform may further contain a database and a number of modules that may help process, parse, analyze and visualize the set of communication and transaction data received from multiple collection servers around the world. In one or more embodiments, the service platform may further contain a notification module, a screening module, an analysis module, a reconstruction module, a real-time media replication module, and others.

The server may be any brand of server and any type of server computer, blade server or any other processing device capable to performing the data management and communication functions with any quantity of cores, e.g. a six (6) core X86 Intel Quad Xeon MP, which may be programmed for any type of operating system (“OS”), e.g., Solaris UNIX, LINUX, or other server computing OS. In one or more embodiments, the system may be run on an Intel86 based processor using Linux RHEL with 64 bit OS. The system may be run on a direct or NAS storage device or appliance. The system is not limited to Intel x86, Linux RHEL, Direct/NAS storages and can be implemented on any computer hardware, OS and storage devices.

B. Real-Time Notification and Replication of Online Chat Conversation

In one or more embodiments, as mentioned above, the service platform may further contain a notification module, a screening module and a real-time media replication module. In one or more embodiments, the notification module may process a particular metadata communicated to the service platform through the communication bus and deduce that the particular metadata is associated with an online chat conversation. Once the notification module has deduced that an online chat conversation is in session between the POI and the correspondent of the POI, the notification module may immediately alert the analyst at the workstation that an online chat conversation has commenced between the POI and the correspondent of the POI. In one or more embodiments the notification module may immediately generate an alert to the analyst.

In one or more embodiments, after the notification module has deduced that an online chat conversation has commenced, the content of the online chat conversation may immediately be transported through the communication bus to the service platform from the collection server. In one or more embodiments, the content associated with the online chat conversation may be further analyzed at the service platform.

In one or more embodiments, the screening module may work in conjunction with the notification module. In one or more embodiments, the screening module may automatically screen at least one of the content and the metadata associated with the online chat conversation. In one or more embodiments, the screening module may screen the content and/or metadata based on a set of predetermined screening criteria specified by the analyst. For example, the analyst may be particularly interested in online chat conversations between the POI and a particular correspondent X. Therefore, the screening module may detect that the online chat conversation is ongoing between the POI and X, and may label the online chat conversation as “IMPORTANT.” In another embodiment, the predetermined screening criteria may screen online chat conversations that contain important keywords. For example, the screening module may label as “IMPORTANT” all chat conversations that contain the word “MURDER.” In one or more embodiments, the analyst may specify any number of predetermined screening criteria. In one or more embodiments, the screening module may also organize a set of online chat conversations based on importance and priority. In one or more embodiments, the screening module may generate a “priority level” based on the predetermined screening criteria. In one or more embodiments, the priority level may be computed based on a set of weights given to various metrics or criteria. For example, the system may set a rule that when the keyword MURDER, as above, appears in the chat conversation, that particular online chat conversation may automatically be given a HIGH priority level. In one or more embodiments, the priority level may be a number, and may be computed by the system based on values inputted by the analyst to compute the priority level. In one or more embodiments, the predetermined screening criteria may be based on a keyword, an identify of a correspondent of the POI, a date of the online chat conversation, a time of the online chat conversation, an attachment type in the online chat conversation, a type of the online chat conversation and other metrics as needed by the analyst. In one or more embodiments, when the priority level is greater than a threshold level, the analyst 110 may receive a special alert to notify the analyst about an especially important online chat conversation. For example, when the priority level is “HIGH,” the analyst may receive a special alert to notify that this particular online chat conversation is especially important, in addition to receiving a regular alert. In one or more embodiments, the analyst 110 may be able to decide the importance and weight of various predetermined screening criteria to help the screening module screen and organize the set of online chat conversations based on priority level.

In one or more embodiments, the real-time media replication module may produce a real-time duplicate transcript of the online chat conversation automatically and simultaneously as the online chat conversation occurs between the POI and the correspondent of the POI. In one or more embodiments, the real-time media replication module may be part of the service platform, and may produce the duplicate chat transcript to be analyzed by the analyst at the workstation. In one or more embodiments, the real-time media replication module may immediately pull the content from the collection server through the communication bus and replicate it. In one or more embodiments, the real-time media replication module may produce the duplicate transcript and store the duplicate transcript in the database at the service platform. In one or more embodiments the real-time media replication module generates the duplicate transcript in real-time. In one or more embodiments, an online chat conversation may consist of multiple notes. In one or more embodiments, an audio or video link or attachment may count as a note in the online chat conversation. In one or more embodiments, a note may be a single statement of the online chat conversation. In one or more embodiments, a note may a smallest unit of communication within the online chat conversation. For example, the POI may type a certain number of character and may then press “ENTER.” This may cause the certain number of characters typed by the POI to reach the correspondent of the POI. This smallest unit may count as a note of the online chat conversation. In one or more embodiments, a note may be a single communication between the POI and the correspondent of the POI. In one or more embodiments, the online chat conversation may have at least one note. In one or more embodiments, the online chat conversation may have notes initiated by the POI, and notes initiated by the correspondent of the POI. In one or more embodiments, the real-time media replication module may update the duplicate transcript automatically as soon as a note in the online chat conversation is entered by at least one of the POI and the correspondent of the POI. For example, in an online chat conversation between the POI and A, there will be notes made by the POI and notes made by A:
POI: Hi
A: How are you?
POI: Are we meeting tonight?
A: Yes, at 8 PM.
   In the example above, the online chat conversation between POI and A contains 4 notes.—two notes initiated by POI and two notes initiated by A. In one or more embodiments, the real-time media replication module populates the transcript with the most recent note as soon as a note (by either the POI or A) is entered. In one or more embodiments, the analyst is able to view the duplicate transcript produced by the real-time media replication module to better analyze the communication between the POI and the correspondent of the POI.

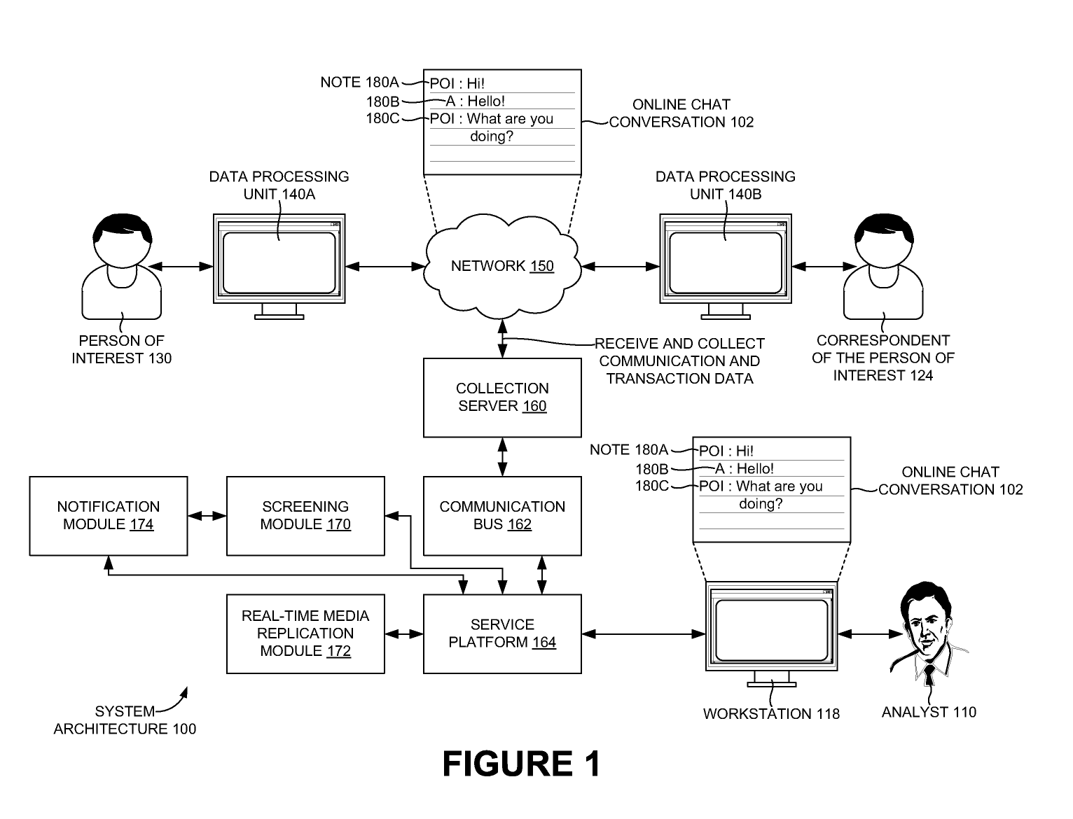

FIG. 1 is a figure of the system architecture and illustrates, in detail, a POI 130, a correspondent of the POI 124, a data processing unit 140A and 140B, a network 150, a probe 132, a notification module 174, a screening module 170, a collection server 160, a service platform 164, a communication bus 162, a real-time media replication module 172 a workstation 118 and an analyst 110.

In one or more embodiments, the collection server may be able to collect the set of communication and transaction data from a data processing unit associated with a person of interest from a network 150. In one or more embodiments, the collection interface module may collect the set of communication and transaction data communication in the online chat conversation between the POI and the correspondent of the POI from the network.

In one or more embodiments, the POI 130 may be engaging in an online chat conversation with a correspondent of the POI 124. In one or more embodiments, the POI 132 may initiate the online chat conversation 102 by entering a note. In another embodiment, the correspondent may initiate the online chat conversation 102 by entering a note. In one or more embodiments, the online chat conversation may occur through any chat vehicle. For example, the chat vehicle may be AIM®, Google® chat, Yahoo® chat messenger or any other chat messenger or chatting system. In one or more embodiments, the collection server may collect the set of communication and transaction data associated with the online chat conversation 102. In one or more embodiments, the metadata associated with the online chat conversation may be transported to the service platform 164 through the communication bus 162. In one or more embodiments, the notification module 174, may immediately notify the analyst 110 of the online chat conversation between the POI and the correspondent of the POI by generating an alert. In one or more embodiments, the metadata and the content related to the online chat conversation may be immediately transmitted through the communication bus to the service platform, so that it can be presented to the analyst 110 at the workstation 118. In another embodiment, the metadata may be instantly transmitted along with the notification and/or alert, and the content may be transmitted separately once the analyst 110 decides that the particular online chat conversation with a particular correspondent is of interest to the analyst 110. In one or more embodiments, the service platform may further contain a real-time media replication module 172 that may duplicate the online chat conversation between the POI and the correspondent of the POI simultaneously, in real time, as the conversation is occurring between the POI and the correspondent of the POI. In one or more embodiments, the real-time media replication module 172 may generate a viewable version of the online chat conversation to the analyst 110 as and when the online chat conversation is happening. In one or more embodiments, the real-time media replication module 172 may save a copy of the duplicate transcript in a storage medium associated with the service platform 164 to be retrieved by the analyst at a later time. In one or more embodiments, as soon as an online chat conversation is initiated, the real-time media replication module 172 may create a folder for all online chat conversations associated with the POR. In one or more embodiments, the analyst may be able to view all online chat conversations by selecting the folder to view all chat conversations. In one or more embodiments, the folder may be organized based on a priority level or any other screening criteria used by the screening module. In one or more embodiments, the set of online chat conversations associated with the POI may be organized by a time of the online chat conversation, a priority level of the online chat conversation, a key word of the online chat conversation and any other predetermined screening criteria.

In one or more embodiments, this may enable the analyst 110 to immediately understand and analyze the particular online chat conversation. In one or more embodiments, the viewable version of the online chat conversation may be a real-time transcript of the online chat conversation occurring between the POI and the correspondent of the POI. In one or more embodiments, the service platform 164 may further be equipped with a screening module to screen the online chat conversation based on a set of predetermined screening criteria, as discussed above.

In one or more embodiments, the collection server 160 may further comprise the data processing engine and a storage module. In one or more embodiments, the service platform 164 may further comprise a database, and a set of other modules to visualize and analyze the set of communication and transaction data. In one or more embodiments, the workstation 118 may be coupled with a user interface allowing the analyst to access, analyze and visualize the set of communication and transaction data.

In one or more embodiments, the collection server 160 may be in a cloud. In one or more embodiments the collection server 160 may be connected to a database of a service provider. The database may also be in a data processing unit associated with the person of interest.

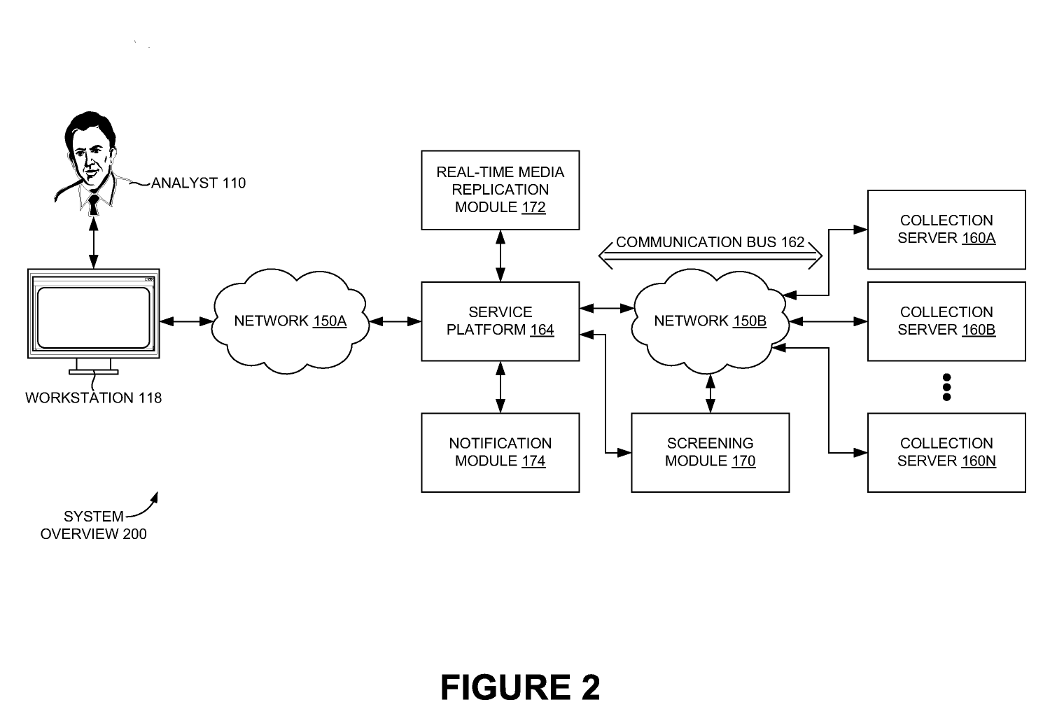

FIG. 2 illustrates the analyst 110, the workstation 118, a wide area network (WAN) 150, the service platform 164, the collection server 160, the communication bus 122, the real-time media replication module 172, the notification module 174 and the screening module 170.

In one or more embodiments, the workstation 118, the service platform 164, the collection server 160 and the communication bus 162 may all be able to communicate with each other through a connection of the WAN. The network may be also be a local network or any other network that may connect the servers with each other.

In one or more embodiments, the workstation 118 being used by the analyst 110 may be connected to the service platform 164 through a particular network, and the communication bus 162 may span another network to connect the collection servers 160 with the service platform 164. In one or more embodiments, the various modules, including, the real-time media replication module 172, the notification module 174, the screening module 170 may all be able to communicate through the network 150 as well.

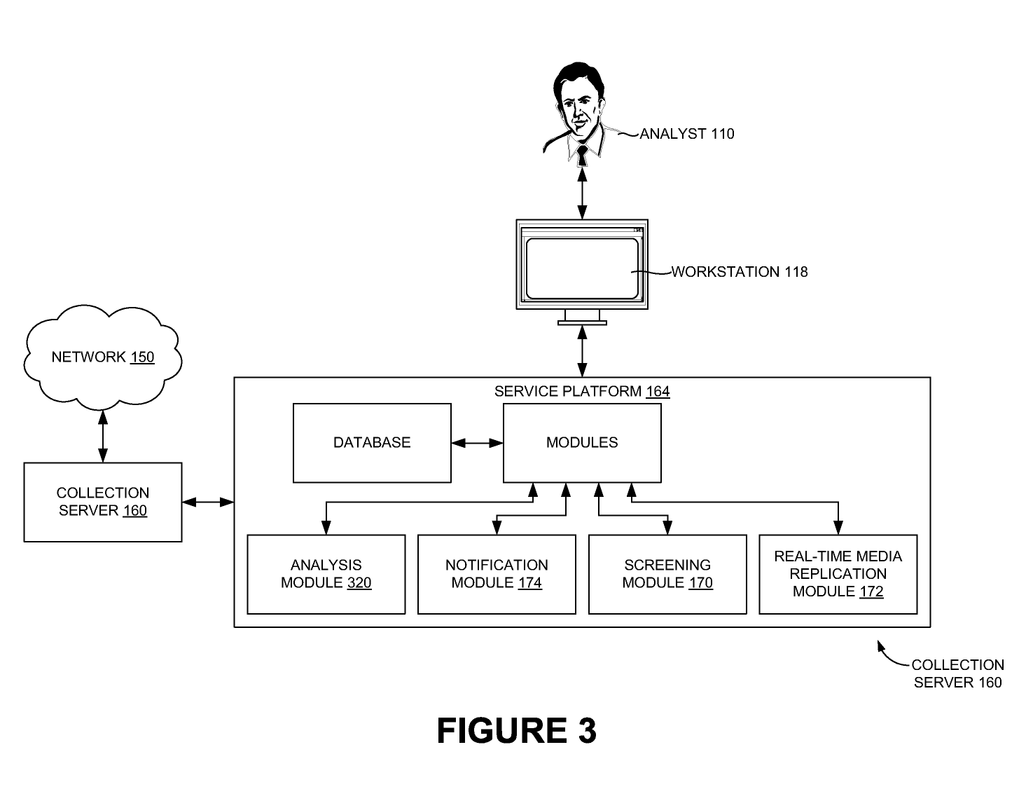

FIG. 3 illustrates a detailed view of the collection server 160 further comprising the collection interface module 320, the service platform 164, the data processing engine 322 and the storage module 324.

In one or more embodiments, the data processing engine 322 may further comprise analysis and processing modules to process and analyze the set of communication and transaction data. The data processing engine may separate the set of communication and transaction data through a set of tags. For example, the data processing engine may extract the metadata and the content based on a data format, a tag and any other predetermined criteria set by the analyst and/or system.

In one or more embodiments, after processing and separating the set of communication and transaction data, the content may be stored locally at the storage module while the metadata and the text content are transmitted through the communication bus to the service platform 164. In one or more embodiments, after the data processing engine separates and organizes the collected data, the metadata and text data may automatically be transported to the service platform 164. In one or more embodiments, the notification module 174 at the service platform may recognize the metadata of the online chat conversation, and may alert the analyst. Based on the identification of the online chat conversation, the content associated with the online chat conversation may also be transported to the service platform through the communication bus. In one or more embodiments, the service platform 164 may further comprise a screening module 170. In one or more embodiments, after the data processing engine 322 has separated the data, the screening module 170 may screen the metadata and the content to assess a priority level of the online chat conversation. In one or more embodiments, the analyst may have selected predetermined criteria and keywords such that the data processing engine of the screening module scans the content of the online chat conversation to determine a priority level of the conversation. For example, the system with the help of the analyst may come up with predetermined keywords that may make a particular online chat conversation “important” or “high priority.” For example, depending on the situation, the analyst may have found a particular code word that the POI frequently uses with correspondents, and may use that particular code word as a keyword. The screening module 170 may screen the online chat conversation for that particular keyword, and automatically label that particular online chat conversation as “important” or “high priority” based on the particular key word. This screening module may also further be linked the notification module 174 such that the notification module sends an additional alert based on the high priority of the particular online chat conversation. In one or more embodiments, the analyst 110 may be able to control the notifications such that the analyst only receives notifications and/or alerts from the system after the screening module has screened the online chat conversation and determined that the particular online conversation is of at least a minimum priority level, as set by the analyst. In one or more embodiments, the service platform may further contain the real-time media replication module 172. In one or more embodiments, the real-time media replication module may automatically and simultaneously produce a duplicate transcript of the online chat conversation in real-time as soon as a single note of the online chat conversation is entered by either the POI or the correspondent of the POI. The analyst 110 may then be able to view a viewable version of the transcript on the workstation in real-time.

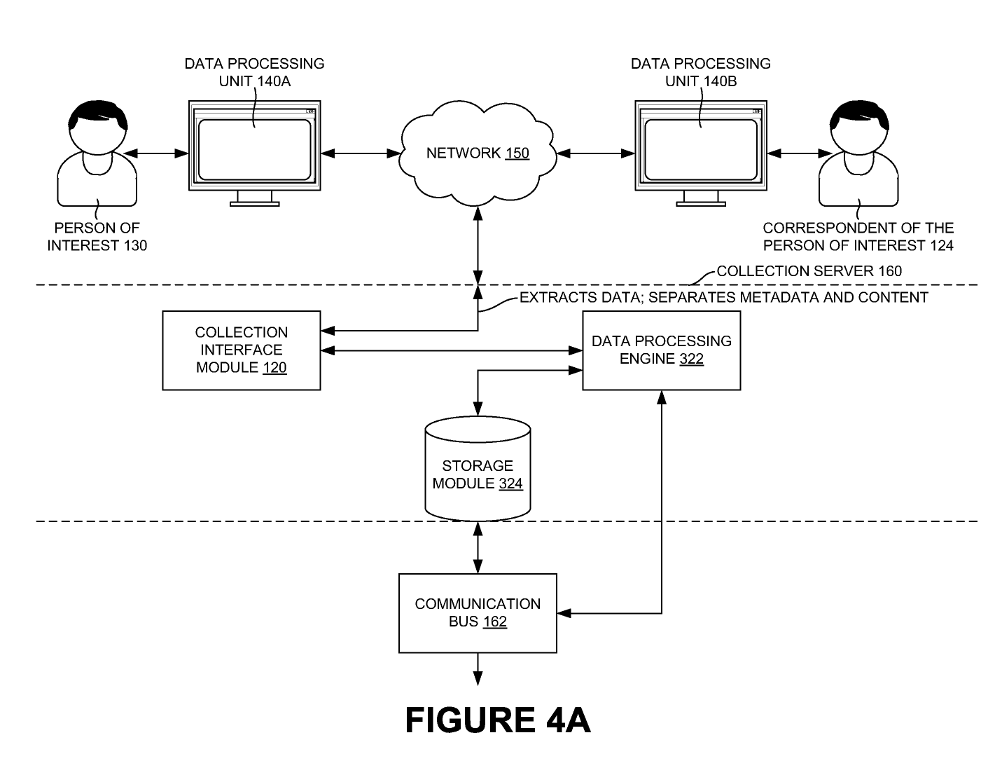

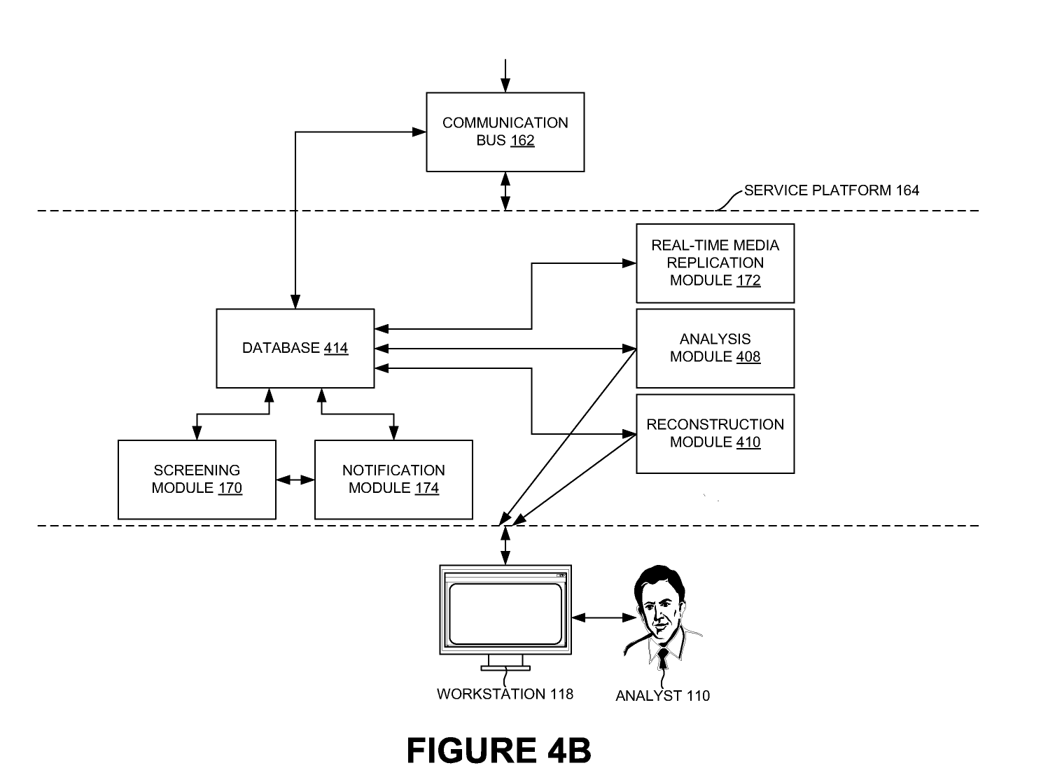

FIGS. 4A and 4B illustrate the screening and notification of online chat conversations between the POI and the correspondent of the POI. In particular, they show the person of interest 130, the correspondent of the POI 124, the network 150, the data processing units 140A and 140B, the collection interface module 120, the data processing engine 322, the storage module 324, the communication bus 162, the screening module 170, the notification module 174, the database 414, the data processing engine 122B, the analysis module 408, the reconstruction module 410, the real-time media replication module 172, the workstation 116 and the analyst 110.

In one or more embodiments, the POI 130 may be engaged in an online chat conversation with a correspondent of the POI 124. The collection server 160 may receive the set of communication and transaction data, in this case the online chat conversation.

In one or more embodiments, the data processing unit, in conjunction with the collection interface module 120 may receive the set of communication and transaction data and process the set of data to extract the metadata and the content of the set of communication and transaction data. The collection interface module 120 and the data processing engine 322 may automatically transmit the metadata and the text content to the service platform 164 through the communication bus 162 in one or more embodiments. In one or more embodiments, the content may be stored in the storage module.

In FIG. 4B, the service platform 164 may receive the metadata and the text content and may store the metadata and the text content in the database 414. In one or more embodiments, the service platform may be coupled with a data processing engine 422B that may in turn be coupled to a processor and a memory. The data processing engine 122B may be further coupled to a set of modules. In one or more embodiments, the service platform 164 may comprise of an analysis module 408, a reconstruction module 410, a visualization module, a screening module, a notification module, a real-time media replication module, a translation module, a retargeting module and other modules. In one or more embodiments, the screening module may screen a particular online chat conversation and determine a priority level based on a set of predetermined screening criteria. In one or more embodiments, the notification module 174 may immediately notify the analyst at the workstation that a particular online chat conversation between the POI and the correspondent has been initiated.

In one or more embodiments, the service platform may be further coupled to a translation module. The translation module, may immediately consult with a translation database to translate, in real-time, the online chat conversation between the POI and the correspondent of the POI.

In one or more embodiments, the service platform 164 may further contain a real-time media replication module 172. In one or more embodiments, the real-time media replication module 172 may generate a duplicate transcript of the online chat conversation in real time as the online chat conversation is ongoing between the POI and the correspondent of the POI. In one or more embodiments, the service platform 106 may be coupled to a set of workstations. The analyst 110 may access the set of communication and transaction data and the analysis of the set of communication and transaction data through an analyst interface associated with the workstation 118.

Although the present embodiments have been described with reference to specific example embodiments, it will be evident that various modifications and changes may be made to these embodiments without departing from the broader spirit and scope of the various embodiments.

What is claimed is:

1. A method comprising:
automatically generating, through a notification module, a notification at a workstation associated with an analyst when a person of interest (POI) engages in an online chat conversation having at least one of a text, voice and video capability with a correspondent of the POI; and
generating in a real-time, through a real-time media replication module, a viewable version of the online chat conversation at the workstation associated with the analyst simultaneously as a note of the online chat conversation is transmitted to the correspondent of the POI.

2. The method of claim 1 further comprising:
populating the viewable version of the online chat conversation between the POI and the correspondent of the POI in a duplicate transcript at the workstation associated with the analyst through the real-time media replication module.

3. The method of claim 1 further comprising:
saving a copy of the duplicate transcript of the online chat conversation at a storage medium of the workstation associated with the analyst.

4. The method of claim 1 further comprising:
automatically creating a folder associated with the POI at the workstation associated with the analyst; and
organizing a set of online chat conversations initiated by the POI through at least one of a time of the online chat conversation, a priority level of the online chat conversation, a key word of the online chat conversation.

5. The method of claim 1 further comprising:
screening the online chat conversation based on a set of predetermined screening criteria,
wherein the set of predetermined screening criteria is at least one of a correspondent of the POI, a time of the online chat conversation, a date of the online chat conversation, an attachment type associated with the online chat conversation, a keyword contained in the online chat conversation;
generating a priority level of the chat conversation based on the set of predetermined screening criteria; and
organizing the set of the online chat conversations based on the priority level of the chat conversations.

6. The method of claim 5 further comprising:
organizing the set of the online chat conversations based on the set of predetermined screening criteria;
generating a priority level of the chat conversation based on the set of predetermined screening criteria; and
generating a special alert when the priority level of the chat conversation is greater than a predetermined threshold level.

7. The method of claim 6 further comprising:
generating a special alert when the priority level of the chat conversation is greater than a predetermined threshold level.

8. The method of claim 1 further comprising:
automatically transmitting a content associated with the online chat conversation between the POI and the correspondent of the POI when the notification module identifies the metadata associated with the online chat conversation as a chat conversation.

9. The method of claim 1 further comprising:
duplicating, in real-time and transmitting at least one of a voice attachment, a data attachment and a video attachment to the analyst when at least one of the voice attachment, the data attachment and the video attachment is transmitted through the online chat conversation between the POI and the correspondent of the POI.

10. The method of claim 1 further comprising:
determining that a particular chat conversation is in a foreign language; and
automatically translating the chat conversation after consulting a translation database.

11. A method comprising:
automatically generating a notification to an analyst when a person of interest (POI) engages in an online chat conversation with a correspondent of the POI;
generating, in a real time, a viewable version of the online chat conversation at a workstation associated with the analyst; and
screening the online chat conversation based on a set of predetermined screening criteria to automatically generate a priority level of the online chat conversation.

12. The method of claim 10 further comprising:
generating the viewable version of the online chat conversation simultaneously as a note of the online chat conversation is transmitted to the correspondent of the POI.

13. The method of claim 12 further comprising:
automatically creating a folder associated with the POI at the workstation associated with the analyst; and
organizing a set of online chat conversations associated with the POI based on at least one of a time of the online chat conversation, a priority level of the online chat conversation, a key word of the online chat conversation.

14. The method of claim 13 further comprising:
determining that a particular chat conversation is in a foreign language; and
automatically translating the chat conversation after consulting a translation database.

15. A system comprising a processor communicatively coupled with a volatile memory and a non-volatile storage further comprising:
a notification module, to automatically generate a notification to an analyst when a person of interest (POI) engages in an online chat conversation having at least one of a text, voice and video capability with a correspondent of the POI;
a real-time media replication module, to generate, in a real time, a viewable version of the online chat conversation, simultaneously as a note of the online chat conversation is transmitted to the correspondent of the POI; and
a workstation associated with an analyst, to view the viewable version of the online chat conversation between the POI and the correspondent of the POI.

16. The system of claim 15 further comprising:
a collection server:
to collect a set of communication and transaction data from a network being used by the POI,
to process the set of communication and transaction data,
to extract a metadata and a content of the set of communication and transaction data, and
to store the content.

17. The system of claim 16 further comprising:
a communication bus, to automatically transmit the metadata and a text content to a service platform from the collection service immediately at a time of collection of the set of communication and transaction data and to transmit the content to the service platform.

18. The system of claim 17 further comprising:
a service platform:
to receive and store the metadata and the text content, and
to present the set of communication and transaction data to the analyst.

19. The system of claim 18 further comprising:
a screening module,
to screen the online chat conversation for a set of predetermined screening criteria,
to organize the set of the online chat conversations based on the set of predetermined screening criteria,
to generate a priority level of the online chat conversation based on the set of predetermined keywords, and
to generate a special alert when the priority level of the online chat conversation is greater than a predetermined threshold level.

20. The system of claim 19 further comprising:
a translation module to determine that a particular chat conversation is in a foreign language, and to automatically translate the chat conversation.
